(19) United States
(12) Patent Application Publication
(10) Pub. No.: US 2010/0127929 A1
(43) Pub. Date: May 27, 2010

(54) POSITION CALCULATING METHOD AND POSITION CALCULATING DEVICE

(75) Inventor: Shuji UCHIDA, Shiojiri (JP)

Correspondence Address: GLOBAL IP COUNSELORS, LLP, 1233 20TH STREET, NW, SUITE 700, WASHINGTON, DC, 20036-2680, US

(73) Assignee: SEIKO EPSON CORPORATION, Tokyo (JP)

(21) Appl. No.: 12/617,480

(22) Filed: Nov. 12, 2009

(30) Foreign Application Priority Data
Nov. 26, 2008 (JP) 2008-300536

(51) Int. Cl. G01S 19/27

(52) U.S. Cl. 342/357.15

(57) ABSTRACT

A position calculating method includes: determining whether satellite orbit data of a positioning satellite having a first effective term and long-term prediction orbit data having a second effective term longer than the first effective term and predicting a satellite orbit of the positioning satellite are retained or not; and calculating a position by using the satellite orbit data when it is determined that the satellite orbit data and the long-term prediction orbit data are retained.

The entire disclosure of Japanese Patent Application No. 2008-300536, filed Nov. 26, 2008 is expressly incorporated by reference herein.

### BACKGROUND

1. Technical Field

The present invention relates to a position calculating method and a position calculating device.

2. Related Art

A GPS (global positioning system) is widely known as a position calculation system using positioning signals. The GPS is included in a position calculating device contained in a cellular phone, a car navigation device, or other units. The GPS performs position calculation for obtaining three-dimensional coordinates indicating the position of the GPS and time errors based on information about positions of plural GPS satellites and pseudo distances between the plural GPS satellites and the GPS.

According to the position calculation by the GPS, the satellite information such as positions, speeds, and moving directions of the GPS satellites is obtained based on navigation data such as almanac and ephemeris superimposed on GPS satellite signals transmitted from the GPS satellites. Almanac is effective for capturing satellites, but is not generally used for position calculation due to insufficient accuracy of satellite orbits. On the other hand, ephemeris is effective for capturing satellites and can be used for position calculation since satellite orbits are sufficiently accurate. Thus, when ephemeris is not retained at the start of position calculation, for example, ephemeris needs to be obtained from the GPS satellite signals at first. Accordingly, time to first fix (TTFF) increases.

The ephemeris superimposed on the GPS satellite signals includes parameter called URA index as index for indicating reliability of satellite orbit. The reliability of the satellite information as ephemeris increases and becomes more appropriate for position calculation as the URA index decreases. For example, JP-A-2003-279637 discloses technology for determining a satellite used for position calculation based on the URA index contained in the ephemeris.

Recently, such a technology has been developed which does not perform position calculation by using ephemeris transmitted from GPS satellites but produces ephemeris effective for a long period such as one week (hereinafter referred to as “long-term prediction ephemeris (long-term prediction orbit data)”) by using an information providing device such as a server to perform position calculation based on the produced long-term prediction ephemeris.

The long-term prediction ephemeris is defined by data format similar to that of normal ephemeris, for example. According to this method, a satellite orbit is approximated using Kepler's elliptic orbit model as one of satellite orbit approximation models, and long-term prediction ephemeris is defined based on parameters calculated by the model expression used in this approximation (hereinafter referred to as “satellite orbit parameters”). Satellite prediction almanac (prediction position data) containing prediction positions as future positions of a positioning satellite predicted in time series at predetermined time intervals is provided by predetermined commercial system. Approximation calculation based on Kepler's elliptic model can be performed by using the satellite orbit almanac.

According to recent finding, however, the prediction positions of the positioning satellite contained in the satellite prediction almanac tend to deviate from the actual positions more greatly as the prediction positions correspond to data for more distant future. Thus, in case of production of long-term prediction ephemeris by approximation calculation based on the Kepler's elliptic orbit model, the satellite orbits obtained by approximation calculation may deviate from the actual satellite orbits more considerably as the satellite orbits correspond to data for more distant future from the production date and time. In this case, the position calculating device performs position calculation based on the long-term prediction ephemeris having low reliability with deviation from the actual satellite orbits, providing a factor of lowering accuracy in position calculation.

### SUMMARY

It is an advantage of some aspects of the invention to provide a technology of increasing accuracy in position calculation.

A first aspect of the invention is directed to a position calculating method including: determining whether satellite orbit data of a positioning satellite having a first effective term and long-term prediction orbit data having a second effective term longer than the first effective term and predicting a satellite orbit of the positioning satellite are retained or not; and calculating a position by using the satellite orbit data when it is determined that the satellite orbit data and the long-term prediction orbit data are retained.

Another aspect of the invention is directed to a position calculating device which includes: a determining unit which determines whether satellite orbit data of a positioning satellite having a first effective term and long-term prediction orbit data having a second effective term longer than the first effective term and predicting a satellite orbit of the positioning satellite are retained or not; and a position calculating unit which calculates a position by using the satellite orbit data when it is determined that the satellite orbit data and the long-term prediction orbit data are retained.

According to the first and other aspects of the invention, whether the satellite orbit data of the positioning satellite having the first effective term and the long-term prediction orbit data having the second effective term longer than the first effective term are retained or not is determined. When it is determined that both of the data are retained, the position is calculated by using the satellite orbit data.

The long-term prediction orbit data is data predicting the satellite orbit of the positioning satellite for the period longer than that of the satellite orbit data, and the reliability of the predicted satellite orbit is lower than that of the satellite orbit of the satellite orbit data. Thus, when both of the satellite orbit data and the long-term prediction orbit data are retained, the long-term prediction orbit data is not used but the satellite orbit data is used in preference to the long-term prediction orbit data for position calculation. By this method, the accuracy of position calculation can be increased.

A second aspect of the invention is directed to the position calculating method of the first aspect which further includes determining whether a time is contained in the first effective term or not. In this case, calculating the position includes calculating the position by using the satellite orbit data when it is determined that the time is contained in the first effective term, and calculating the position by using the long-term prediction orbit data when it is determined that the time is not contained in the first effective term.

According to the second aspect of the invention, the position is calculated by using the satellite orbit data when it is determined that the time is contained in the first effective term which is an effective term of satellite orbit data, and the position is calculated by using the long-term prediction orbit data when it is determined that the time is not contained in the first effective term. When the time is not contained in the first effective term, the position cannot be calculated by using the satellite orbit data. Thus, it is preferable that the position is calculated by using the long-term prediction orbit data.

A third aspect of the invention is directed to the position calculating method of the first or second aspect, wherein: the positioning satellite modulates a positioning signal by satellite orbit data of the positioning satellite and transmits the modulated positioning signal; the position calculating method further includes obtaining the satellite orbit data by receiving the positioning signal; and calculating the position includes calculating the position by using the long-term prediction orbit data in case that the satellite orbit data is not retained according to the determination and that acquisition of the satellite orbit data is not completed.

According to the third aspect of the invention, the satellite orbit data is obtained by receiving the positioning signal. In case that the satellite orbit data is not retained according to the determination and that acquisition of the satellite orbit data is not completed, the position is calculated by using the long-term prediction orbit data. Generally, several tens of seconds are required to obtain the satellite orbit data from the positioning signal. Thus, it is preferable that the position is calculated by using the long-term prediction orbit data when acquisition of the satellite orbit data is not completed.

A fourth aspect of the invention is directed to the position calculating method of any of the first through third aspects, wherein calculating the position includes calculating the position by using the long-term prediction ephemeris in case that the satellite orbit data is not retained and that the long-term prediction orbit data is retained according to the determination.

According to the fourth aspect of the invention, the position is calculated by using the long-term prediction ephemeris in case that the satellite orbit data is not retained and that the long-term prediction orbit data is retained according to the determination. It is preferable that the position is calculated by using the long-term prediction orbit data when the satellite orbit data is not retained.

A fifth aspect of the invention is directed to the position calculating method of any of the first through fourth aspects which further includes receiving the satellite orbit data from an information providing device when it is determined that the satellite orbit data is not retained.

According to the fifth aspect of the invention, the satellite orbit data is obtained from the information providing device when it is determined that the satellite orbit data is not retained. The information providing device is a server which produces or obtains satellite orbit data to provide the satellite orbit data, for example. When satellite orbit data is not retained, satellite orbit data is received from the information providing device and used for position calculation. Thus, highly accurate position calculation can be achieved.

### BRIEF DESCRIPTION OF THE DRAWINGS

The invention will be described with reference to the accompanying drawings, wherein like numbers reference like elements.

FIG. 1 shows a general structure of a position calculation system.

FIG. 2 is a graph showing an example of prediction errors varying with time.

FIG. 3 shows an example of table structure of a prediction orbit reliability determining table.

FIG. 4 is a block diagram showing a function structure of a cellular phone.

FIG. 5 shows an example of data stored in a ROM of the cellular phone.

FIG. 6 shows an example of data stored in a flash ROM of the cellular phone.

FIG. 7 shows an example of data stored in a RAM of the cellular phone.

FIG. 8 shows an example of data structure of ephemeris data for each satellite.

FIG. 9 shows an example of data structure of long-term prediction ephemeris data.

FIG. 10 shows an example of data structure of prediction ephemeris.

FIG. 11 is a flowchart showing flow of a main process.

FIG. 12 is a flowchart showing flow of a position calculation process.

FIG. 13 is a flowchart showing flow of the position calculation process.

FIG. 14 is a flowchart showing flow of a second main process.

FIG. 15 is a flowchart showing flow of a second position calculation process.

### DESCRIPTION OF EXEMPLARY EMBODIMENT

A preferred embodiment according to the invention is hereinafter described with reference to the drawings. It is intended, however, that the invention is not limited to this embodiment.

### 1. System Structure

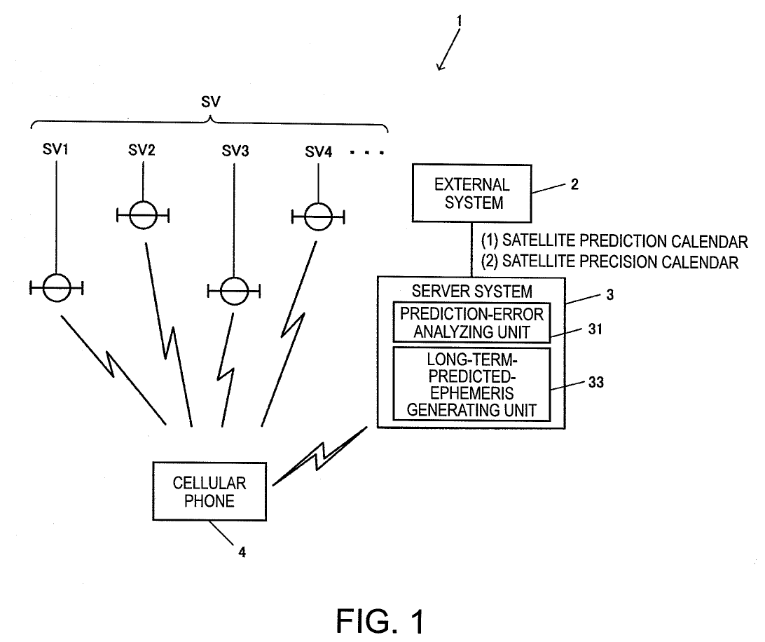

FIG. 1 illustrates a general structure of a position calculation system 1 according to this embodiment. The position calculation system 1 includes an external system 2, a server system 3 as a type of information providing device, a cellular phone 4 as an electronic device having a position calculation device, and a plurality of GPS satellites SV (SV1, SV2, SV3, SV4, and others) as positioning satellites. Position calculation can be performed by the GPS satellites SV and the cellular phone 4 having necessary data received from the server system 3. Thus, it is considered that the cellular phone 4 and the GPS satellites SV constitute a position calculation system. It is also considered that the server system 3 and the cellular phone 4 constitute a position calculation system on the ground.

The external system 2 is a known system which periodically receives satellite signals from the GPS satellites SV, and produces satellite prediction almanac based on navigation data and the like contained in the satellite signals to provide the satellite prediction almanac to the server system 3. The satellite prediction almanac provided by the external system 2 is position data showing predicted future positions of the respective GPS satellites SV as prediction positions and predicted errors of atomic clocks provided on the GPS satellites SV as clock prediction errors disposed in time series at predetermined time intervals (such as 15 minutes intervals).

The external system 2 provides not only the satellite prediction almanac as future data but also past fact data. More specifically, the external system 2 produces satellite precision almanac as past fact data containing actual positions of the GPS satellites SV and actual errors of atomic clocks provided on the GPS satellites SV as clock actual errors, and provides the satellite precision almanac to the server system 3. Since calculation of the actual positions and clock actual errors is a known method, detailed explanation of this calculation is not given herein. The external system 2 corresponds to a computer system of a private or public organization providing satellite prediction almanac and satellite precision almanac, for example.

The server system 3 is a system including a server which obtains satellite prediction almanac and satellite precision almanac from the external system 2, and produces and provides ephemeris predicted for all of the GPS satellites SV and effective for a long period of at least one day such as one week (hereinafter referred to as “long-term prediction ephemeris” in this embodiment which also corresponds to long-term effective orbit and thus can be referred to as long-term prediction orbit data as well) by using the satellite prediction almanac and satellite precision almanac. The effective term of the ephemeris contained in the GPS satellite signals transmitted from the GPS satellites SV (first effective term) is 4 hours. Thus, the effective term of the long-term prediction ephemeris (second effective term) is longer than 4 hours.

The cellular phone 4 is an electronic device through which a user receives and transmits telephone communication, mails and the like, and includes a position calculating device providing a position calculating function as well as an original function such as reception and transmission of telephone communication and mails as a cellular phone. The cellular phone 4 sends a request signal for requesting long-term prediction ephemeris to the server system 3 in response to operation by the user, and receives the long-term prediction ephemeris from the server system 3. The cellular phone 4 also obtains ephemeris by decoding the GPS satellite signals transmitted from the GPS satellites SV. Then, the cellular phone 4 captures the GPS satellites SV by using the ephemeris or the long-term prediction ephemeris thus received, and performs position calculation based on the GPS satellite signals.

### 2. Principle

The server system 3 produces long-term prediction ephemeris by using satellite prediction almanac obtained from the external system 2. More specifically, the server system 3 divides a production target period for one week from the long-term prediction ephemeris production date and time into a plurality of terms for approximation and modeling of satellite orbits (hereinafter referred to as “prediction target terms”). In this embodiment, each length of the prediction target terms is equally 6 hours. Thus, the production target period for one week is divided into 28 prediction target terms (from 1st prediction target term to 28th prediction target term) at 6 hours intervals.

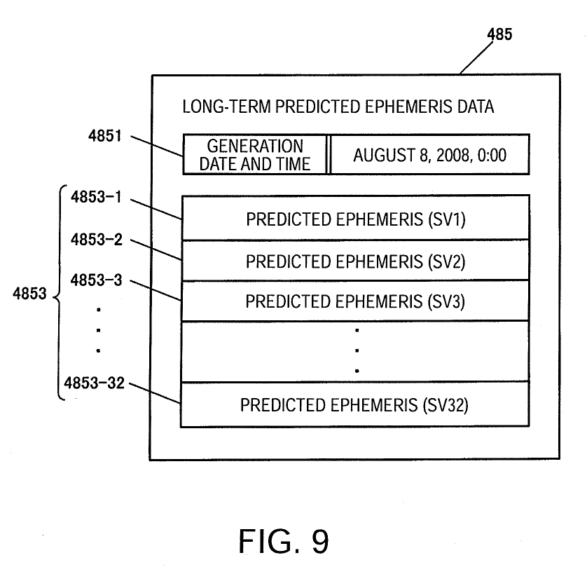

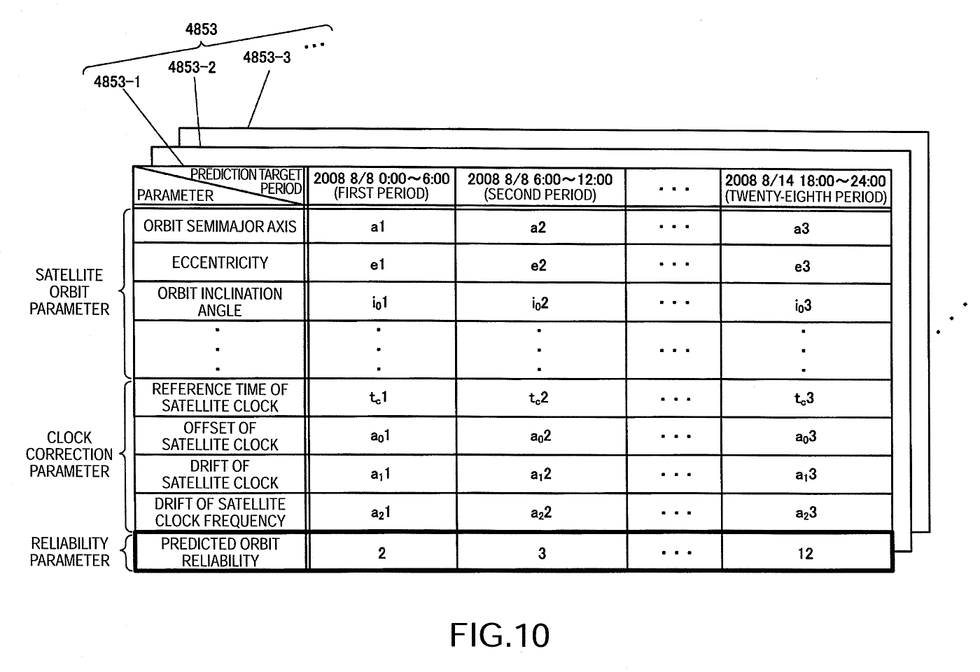

Then, the server system 3 extracts prediction positions in the respective prediction target terms from the prediction positions contained in the satellite prediction almanac obtained from the external system 2. Then, Kepler's satellite orbit model expression in which the sum of squares of the distances from all the extracted prediction positions becomes the minimum (hereinafter referred to as “approximation model” as well) is obtained for each of the prediction target terms. Parameters of the approximation model expressions of the satellite orbits obtained in this step are referred to as “satellite orbit parameters”, and the calculations used for calculating the approximation models are referred to as “approximation calculation” as well. The satellite orbits predicted based on the approximation calculation are referred to as “prediction orbits”. The long-term prediction ephemeris is data storing satellite orbit parameters of all the GPS satellites for all the prediction target terms (see FIGS. 9 and 10).

The prediction positions of the GPS satellites SV contained in the satellite prediction almanac tend to deviate from the actual positions of the GPS satellites SV more greatly as the prediction positions correspond to data for more distant future. Thus, in case of production of long-term prediction ephemeris by approximation calculation, the prediction orbits obtained by approximation calculation may deviate from the actual satellite orbits more considerably as the prediction orbits correspond to data for more distant future from the production date and time.

In this embodiment, the server system 3 determines “prediction orbit reliability” as index showing reliability of the prediction orbits for the respective prediction target terms of the respective GPS satellites, and provides the determined prediction orbit reliability as reliability parameter contained in the long-term prediction ephemeris to the cellular phone 4. In this embodiment, the prediction orbit reliability is expressed by 13 levels from “0” to “12”. According to the levels, “0” indicates the highest reliability, and “12” indicates the lowest reliability of the prediction orbits. The setting of the numeral ranges of the prediction orbit reliability can be varied as necessary. For example, the reliability may be expressed by 16 levels from “0” to “15”. The prediction orbit reliability corresponds to “URA index” contained in the ephemeris.

The specific structure of the server system 3 is now discussed. The server system 3 includes a prediction error analyzing unit 31 as a function unit for analyzing prediction errors, and a long-term prediction ephemeris producing unit 33 as a function unit for producing long-term prediction ephemeris. The prediction error analyzing unit 31 calculates and analyzes prediction errors as distances between the prediction positions contained in the satellite prediction almanac and the actual positions contained in the satellite precision almanac for the respective dates and times (such as 15 minutes interval) associated with the data contained in the satellite prediction almanac received from the external system 2 for each of the GPS satellites SV.

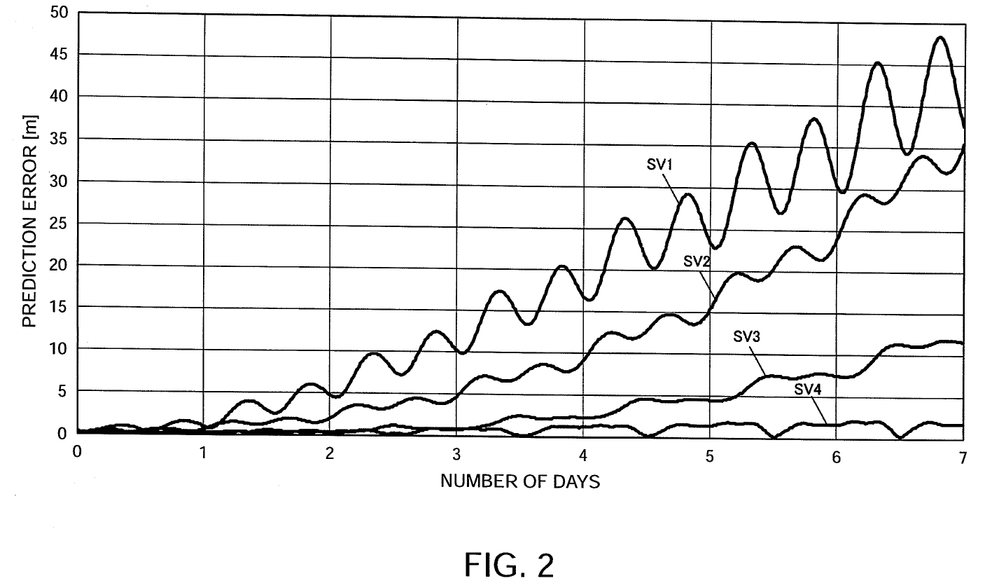

FIG. 2 shows an example of graph on which prediction errors are plotted. The graph shows prediction errors of the four GPS satellites SV1 through SV4 as representative satellites plotted in time series for one week. In FIG. 2, the horizontal axis indicates the number of dates, and the vertical axis indicates prediction errors. As apparent from the figure, the prediction errors of all the GPS satellites SV gradually increase while fluctuating with elapse of time. Particularly, the prediction errors of the GPS satellite SV1 rapidly increase while greatly fluctuating. Thus, the prediction orbit reliability is set in such a manner as to decrease as the reliability corresponds to the prediction orbit in the later prediction target term from the long-term prediction ephemeris production date and time.

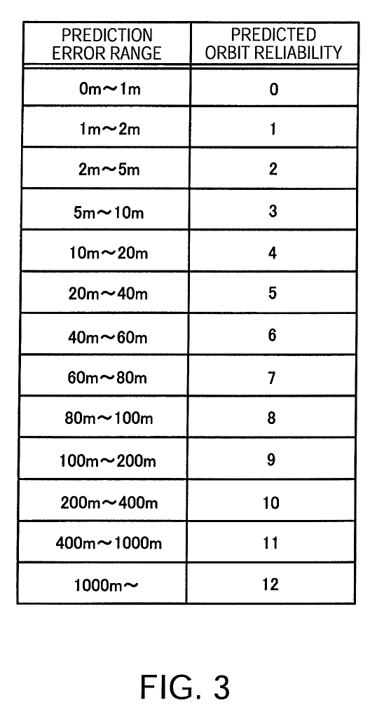

The long-term prediction ephemeris producing unit 33 sets prediction orbit reliability based on the prediction errors calculated by the prediction error analyzing unit 31. More specifically, the long-term prediction ephemeris producing unit 33 sets prediction errors with reference to a prediction orbit reliability setting table shown in FIG. 3. The prediction orbit reliability setting table stores prediction error ranges containing prediction errors and prediction orbit reliabilities each of which is set when a prediction error is contained in the corresponding prediction error range in association with one another. According to this table, the prediction error ranges and the prediction orbit reliabilities are determined such that the prediction orbit reliabilities rise as the prediction errors increase.

The long-term prediction ephemeris producing unit determines which prediction error range contains the prediction error in each of the prediction target terms. Then, the long-term prediction ephemeris producing unit 33 reads the prediction orbit reliability corresponding to the determined prediction error range and sets this prediction orbit reliability as prediction orbit reliability in the corresponding prediction target term. The prediction error can be calculated for each of the date and time contained in the satellite prediction almanac. However, the prediction error for each of the prediction target terms can be determined as the average of the prediction errors (average prediction error) at all of the dates and times in the corresponding prediction target term, for example.

The cellular phone 4 receives long-term prediction ephemeris storing satellite orbit parameters, clock correction parameters, and prediction orbit reliabilities as reliability parameters in all of the prediction target terms (from 1st prediction target term to 28th prediction target term) for all of the GPS satellites (SV1 through SV32) from the server system 3, and stores these parameters. As discussed above, the value of the prediction orbit reliability stored in the long-term prediction ephemeris tends to increase (prediction orbit reliability lowers) as the prediction orbit reliability corresponds to data in the later prediction target term.

On the other hand, the respective GPS satellites SV modulate the GPS satellite signals based on the ephemeris as satellite orbit data of the GPS satellites SV and transmit the modulated GPS satellite signals. The cellular phone 4 captures the GPS satellite signals transmitted from the respective GPS satellites SV and demodulates the captured GPS satellite signals to obtain ephemeris. The effective term of the ephemeris is 4 hours which is shorter than 6 hours as the length of the respective prediction target terms of the long-term prediction ephemeris. The ephemeris stores satellite orbit parameter, the clock correction parameter, and the prediction orbit reliability as reliability parameter of the corresponding GPS satellite for the corresponding effective term. Thus, the data structure of the long-term prediction ephemeris for each of the prediction target terms is equivalent to the data structure of the ephemeris.

The prediction orbit reliability contained in the ephemeris obtained from the GPS satellites SV has “0” or “1” in most cases, which corresponds to extremely high reliability of prediction orbit. On the other hand, the prediction orbit reliability contained in the long-term prediction ephemeris is sometimes “2” or “3” even in the oldest prediction target term. Moreover, the value of the prediction orbit reliability increases as the reliability corresponds to data for the later prediction target term.

According to this embodiment, the cellular phone 4 determines whether ephemeris and long-term prediction ephemeris are retained. When it is determined that both of these data are retained, the cellular phone 4 uses the ephemeris for satellite capture and position calculation in preference to the long-term prediction ephemeris so as to perform more accurate position calculation.

However, 20 to 30 seconds are generally required to obtain the ephemeris from the GPS satellite signals, since the phase of the GPS satellite signals is modulated by the data of the ephemeris. Thus, satellite capture and position calculation using the ephemeris cannot be performed from start of reception of the GPS satellite signals until acquisition of the ephemeris. Thus, in case that ephemeris is not retained and that acquisition of the ephemeris is not completed, the cellular phone 4 performs satellite capture and position calculation by using long-term prediction ephemeris. After acquisition of ephemeris is finished, the cellular phone 4 executes satellite capture and position calculation using the obtained ephemeris.

When it is determined that neither ephemeris nor long-term prediction ephemeris is retained, the cellular phone performs process for obtaining long-term prediction ephemeris from the server system 3. Then, the cellular phone 4 executes satellite capture and position calculation by using the obtained long-term prediction ephemeris.

### 3. Function Structure

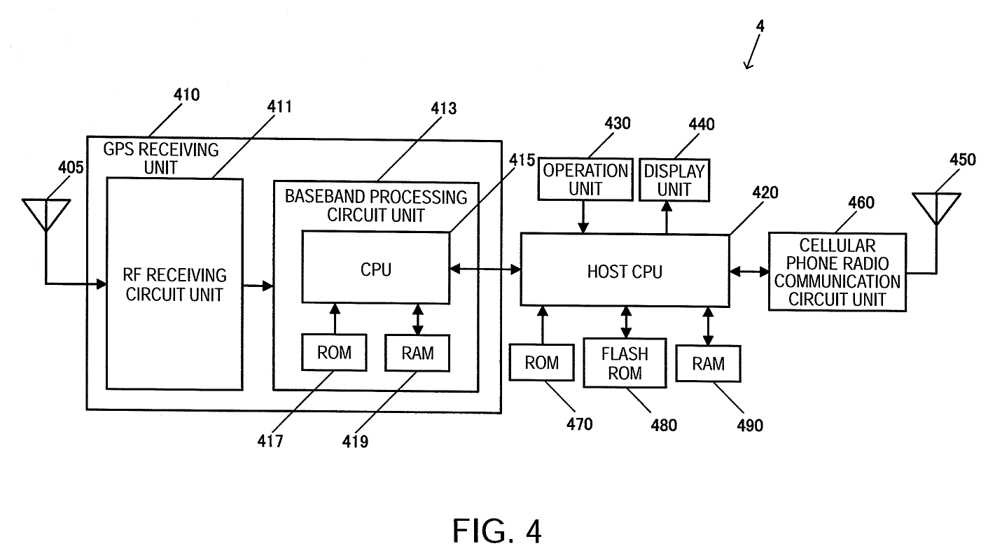

FIG. 4 is a block diagram showing the function structure of the cellular phone 4. The cellular phone 4 includes a GPS antenna 405, a GPS receiving unit 410, a host CPU 420, an operation unit 430, a display unit 440, a cellular phone antenna 450, a cellular phone wireless communication circuit unit 460, a ROM 470, a flash ROM 480, and a RAM 490.

The GPS antenna 405 is an antenna which receives RF (radio frequency) signals containing GPS satellite signals transmitted from the GPS satellites SV, and outputs the received signals to the GPS receiving unit 410. The GPS satellite signals are communication signals having 1.57542 [GHz] and modulated by direct spectrum diffusion system using PRN (pseudo random noise) codes as a type of diffusion codes different for each satellite. The PRN codes are pseudo random noise codes having repetitive cycle of 1 ms and having code length of 1,023 chips as 1 PN frame.

The GPS receiving unit 410 is a position calculation circuit for calculating positions based on the signals outputted from the GPS antenna 405 as a function block corresponding to a so-called GPS receiver. The GPS receiving unit 410 includes an RF (radio frequency) receiving circuit unit 411, and a baseband processing circuit unit 413. The RF receiving circuit unit 411 and the baseband processing circuit unit 413 can be manufactured as separate LSI (large scale integration), or as 1 chip unit.

The RF receiving circuit unit 411 is a circuit block for processing RF signals, and produces oscillation signals to be multiplied by RF signals by dividing or multiplying predetermined local oscillation signals. The RF signals outputted from the GPS antenna 405 are multiplied by the produced oscillation signals to be down-converted into intermediate frequency signals (hereinafter referred to as “IF (intermediate frequency) signals”). Then, the IF signals are amplified or processed in other ways, and converted into digital signals by an A/D (analog/digital) converter to be outputted to the baseband processing circuit unit 413.

The baseband processing circuit unit 413 is a circuit unit for capturing and extracting GPS satellite signals by applying correlation process or the like to the IF signals outputted from the RF receiving circuit unit 411. The baseband processing circuit unit 413 has a CPU 415 as a processor, and a ROM 417 and a RAM 419 as memories.

The CPU 415 obtains ephemeris data for each satellite 483 by decoding the GPS satellite signals. The CPU 415 captures and extracts the GPS satellite signals by using the ephemeris data for each satellite 483 obtained from the GPS satellites SV or long-term prediction ephemeris data 485 obtained from the server system 3 under the control of the host CPU 420.

The host CPU 420 is a processor which collectively controls the respective units of the cellular phone 4 according to various programs such as a position calculation program and a system program stored in the ROM 470. The host CPU 420 performs position calculation by using the ephemeris data for each satellite 483 obtained by the baseband processing circuit unit 413 or the long-term prediction ephemeris data 485 obtained from the server system 3. Then, the host CPU 420 displays a navigation screen where calculated positions resulting from position calculation are plotted on the display unit 440.

The operation unit 430 is an input device which includes a touch panel, button switches and the like, and outputs signals corresponding to pressed icons and buttons to the host CPU 420. Various types of commands such as a telephone communication request, a mail transmission and reception request, and a GPS startup request are inputted through operation of the operation unit 430.

The display unit 440 is a display device constituted by LCD (liquid crystal display) or the like to provide various displays corresponding to display signals received from the host CPU 420. The display unit 440 displays a navigation screen, time information and the like.

The cellular phone antenna 450 is an antenna which transmits and receives cellular phone wireless signals to and from a wireless base station established by a communication service provider of the cellular phone 4.

The cellular phone wireless communication circuit unit 460 is a cellular phone communication circuit unit including an RF converting circuit, a baseband processing circuit and the like. The cellular phone wireless communication circuit unit 460 provides telephone communication, mail transmission and reception, and the like by modulating and demodulating cellular phone wireless signals and other processes.

The ROM 470 is a non-volatile read-only memory unit which stores various programs and data such as a system program for controlling the cellular phone 4 by the host CPU 420, a position calculation program for performing position calculation, and a navigation program for providing navigation function.

The flash ROM 480 is a readable and writable non-volatile memory unit which stores various programs and data for controlling the cellular phone 4 by the host CPU 420 similarly to the ROM 470. The data stored in the flash ROM 480 is not lost even after the power source of the cellular phone 4 is cut off.

The RAM 490 is a readable and writable volatile memory unit which has a work area for temporarily storing the system program performed by the host CPU 420, the position calculation program, various processing programs, data used during various processes, process results and the like.

### 4. Data Structure

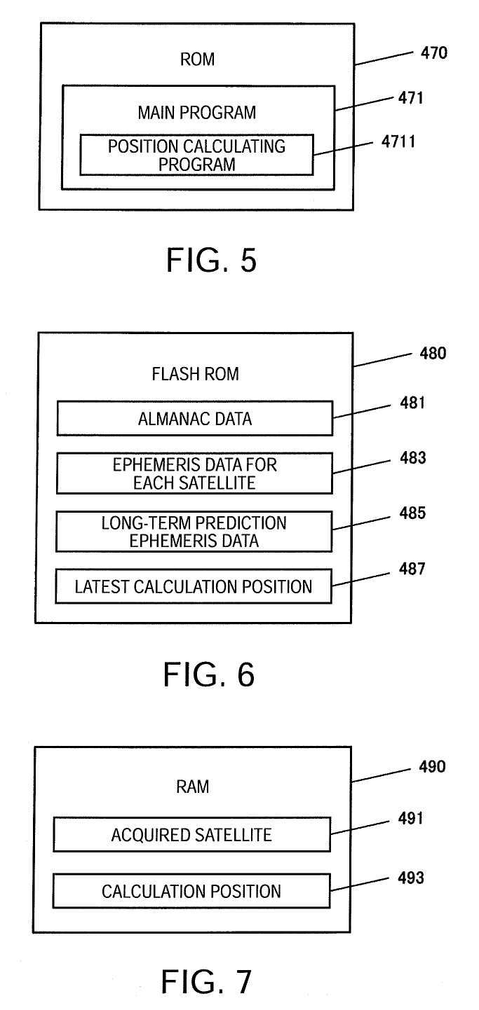

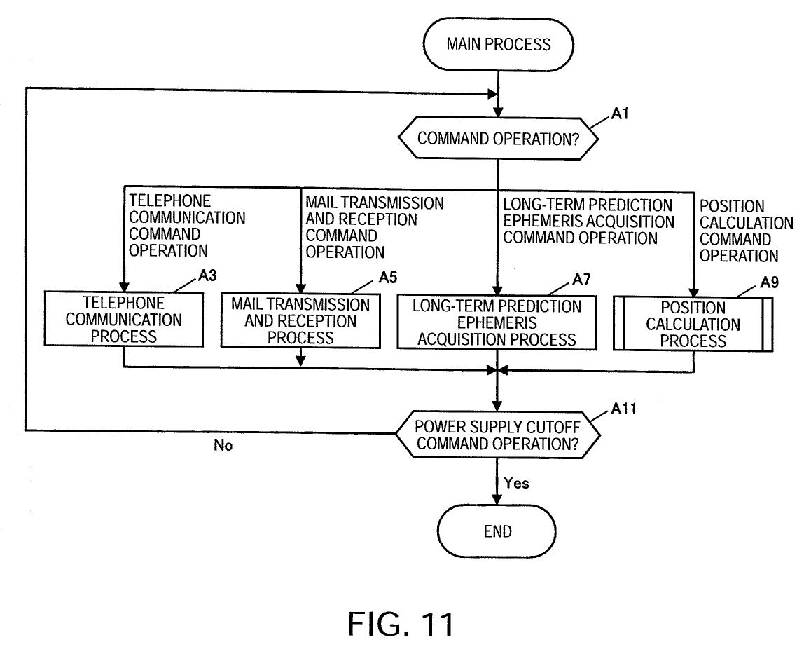

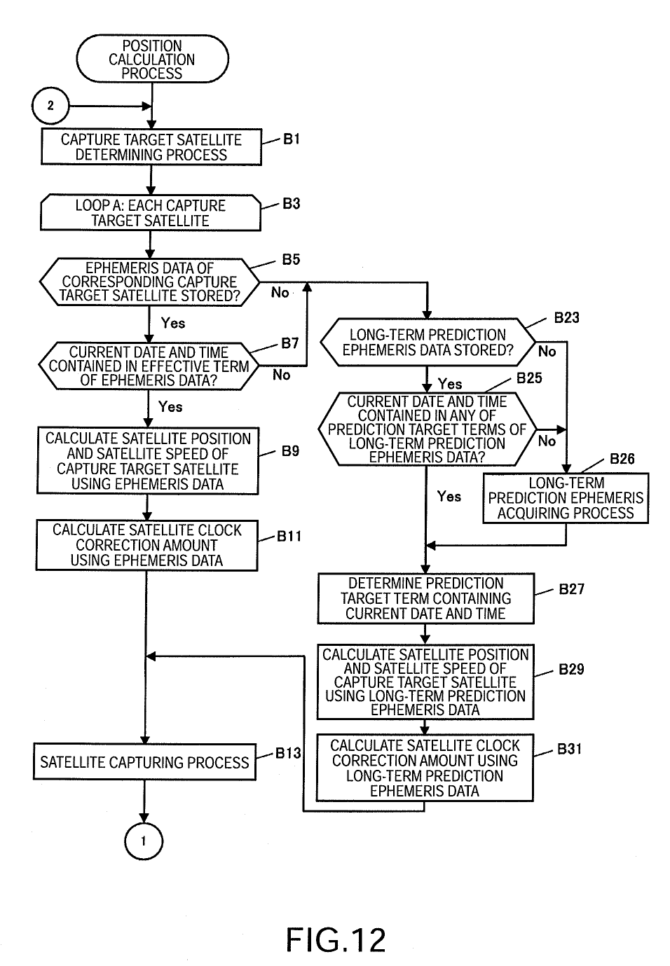

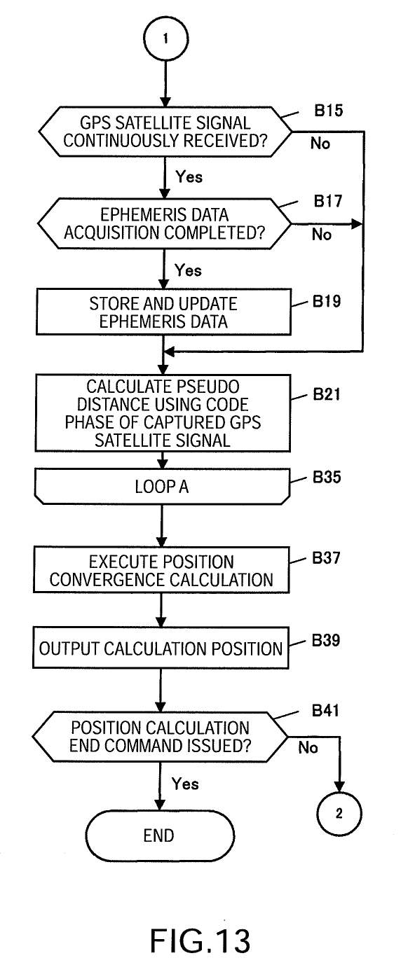

FIG. 5 shows an example of data stored in the ROM 470. The ROM 470 stores a main program 471 to be read and performed by the host CPU 420 as a main process (see FIG. 11). The main program 471 contains a position calculation program 4711 performed as position calculation process (see FIGS. 12 and 13) in the form of sub routine.

In the main process, the host CPU 420 performs process for providing telephone communication and mail transmission and reception as the original function of the cellular phone 4, process for obtaining the long-term prediction ephemeris data 485 from the server system 3, process for calculating the position of the cellular phone 4, and other processes. The main process will be described in detail later with reference to a flowchart.

In the position calculation process, the host CPU 420 causes the baseband processing circuit unit 413 to capture the GPS satellite signals by using the ephemeris data for each satellite 483 obtained from the GPS satellites SV or the long-term prediction ephemeris data 485 obtained from the server system 3, and calculates and outputs the position of the cellular phone 4 based on the captured GPS satellite signals. The position calculation process will be also described in detail later with reference to a flowchart.

FIG. 6 shows an example of data stored in the flash ROM 480. The flash ROM 480 stores almanac data 481, the ephemeris data for each satellite 483, the long-term prediction ephemeris data 485, and a latest calculation position 487 as a position calculated by latest position calculation.

The almanac data 481 is data which stores parameters indicating satellite orbits of all of the GPS satellites SV for a predetermined period (such as one week). The accuracy of the satellite orbits contained in the almanac data 481 is lower than the accuracy of the satellite orbits contained in the ephemeris data for each satellite 483 and the accuracy of the prediction orbits contained in the long-term prediction ephemeris data 485. Thus, the almanac data 481 can be used for determination of a capture target satellite but cannot be used for position calculation.

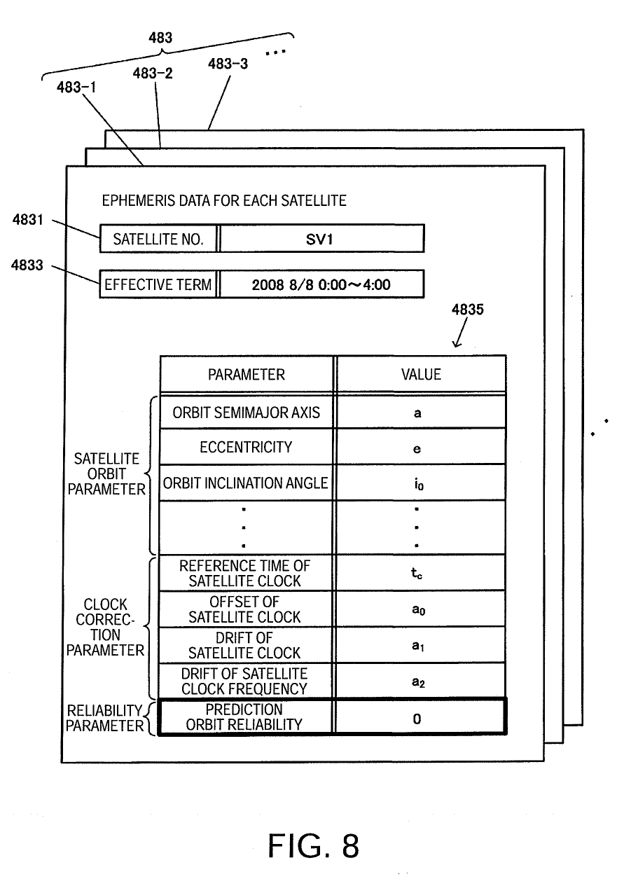

FIG. 8 shows an example of data structure of the ephemeris data for each satellite 483. The ephemeris data 483 for each satellite 483 (483-1, 483-2, 483-3, and others) is data storing ephemeris for each satellite, and contains satellite number 4831, ephemeris effective term 4833, and ephemeris 4835 in association with one another.

The ephemeris 4835 stores Kepler's satellite orbit parameters such as orbit semimajor axis, eccentricity, and orbit inclination angle, clock correction parameters such as reference time of satellite clock, offset of satellite clock, drift of satellite clock, and drift of satellite clock frequency, and prediction orbit reliability as reliability parameter.

For example, the ephemeris data for each satellite 483-1 is data for the satellite “SV1”, and the effective term of the ephemeris is “0:00, Aug. 8, 2008 through 4:00, Aug. 8, 2008”. The eccentricity of the satellite orbit parameters contained in the ephemeris is “e”, and the offset of the satellite clock contained in the clock correction parameters is “a₀”. The prediction orbit reliability as reliability parameter is “0”.

In the main process, the host CPU 420 performs satellite capturing process. The host CPU 420 causes the CPU 415 of the baseband processing circuit unit 413 to capture the GPS satellite signals of the capture target satellite and demodulate the GPS satellite signals to obtain ephemeris data. Then, the host CPU 420 stores the obtained ephemeris data in the flash ROM 480 as the ephemeris data for each satellite 483.

FIG. 9 shows an example of data structure of the long-term prediction ephemeris data 485. The long-term prediction ephemeris data 485 stores production date and time 4851 of long-term prediction ephemeris data, and prediction ephemeris 4853 (4853-1 through 4853-32) of the GPS satellites SV1 through SV32 in association with one another.

FIG. 10 shows an example of data structure of the prediction ephemeris 4853. The prediction ephemeris 4853 (4853-1, 4853-2, and up to 4853-32) stores Kepler's satellite orbit parameters such as orbit semimajor axis, eccentricity, and orbit inclination angle, clock correction parameters such as reference time of satellite clock, offset of satellite clock, drift of satellite clock, and drift of satellite clock frequency, and prediction orbit reliability as reliability parameter for each of the prediction target terms.

For example, the prediction ephemeris 4853-1 is prediction ephemeris for the GPS satellite “SV1”, and the production target period of the prediction ephemeris is one week of “0:00, Aug. 8, 2008 through 24:00, Aug. 14, 2008”. The eccentricity of the satellite orbit parameters contained in the first prediction target term of “0:00, Aug. 8, 2008 through 6:00, Aug. 8, 2008” is “e1”, and the offset of the satellite clock contained in the clock correction parameters is “a₀1”. The prediction orbit reliability as reliability parameter is “2”.

The long-term prediction ephemeris producing unit 33 of the server system 3 calculates satellite orbit parameter, clock correction parameter, and reliability parameter of each of the GPS satellites SV for each of the prediction target terms to produce the prediction ephemeris 4853. Then, the long-term prediction ephemeris producing unit 33 collects the prediction ephemeris 4853 for all of the GPS satellites SV to produce the long-term prediction ephemeris data 485 containing the prediction ephemeris 4853 in association with the production date and time 4851. When receiving request from the cellular phone 4, the long-term prediction ephemeris producing unit 33 transmits and provides the long-term prediction ephemeris 485 to the cellular phone 4.

The host CPU 420 of the cellular phone 4 performs the long-term prediction ephemeris acquisition process, and transmits a request signal for requesting the long-term prediction ephemeris data 485 to the server system 3 in the main process. Then, the host CPU 420 receives the long-term prediction ephemeris data 485 from the server system 3 and stores the long-term prediction ephemeris data 485 in the flash ROM 480.

FIG. 7 shows an example of data stored in the RAM 490. The RAM 490 stores capture satellite 491 as identification information of the captured GPS satellites, and calculation position 493 as position coordinates of the position calculated by the position calculation. These data are updated by the host CPU 420 in the position calculation process.

### 5. Flow of Process

FIG. 11 is a flowchart showing the flow of the main process performed by the cellular phone 4 under the main program 471 stored in the ROM 470 and read and performed by the host CPU 420.

The main process starts when the host CPU 420 detects that the user has executed power ON operation through the operation unit 430. Though not particularly explained, reception of RF signals by the GPS antenna 405 and down-conversion of RF signals into IF signals by the RF receiving circuit unit 411 are carried out while the main process is performed. In this condition, IF signals are outputted to the baseband processing circuit unit 413 as necessary.

Initially, the host CPU 420 determines command operation given through the operation unit 430 (step A1). When it is determined that the command operation is telephone communication command operation (step A1; telephone communication command operation), telephone communication process is performed (step A3). More specifically, the host CPU 420 causes the cellular phone wireless communication circuit unit 460 to provide base station communication with the wireless base station such that telephone communication can be provided between the cellular phone 4 and other device.

When it is determined that the command operation is mail transmission and reception command operation in step A1 (step A1; mail transmission and reception command operation), the host CPU 420 performs mail transmission and reception process (step A5). More specifically, the host CPU 420 causes the cellular phone wireless communication circuit unit 460 to provide base station communication with the wireless base station such that mail transmission and reception can be provided between the cellular phone 4 and other device.

When it is determined that the command operation is long-term prediction ephemeris acquisition command operation in step A1 (step A1; long-term prediction ephemeris acquisition command operation), the host CPU 420 performs long-term prediction ephemeris acquisition process (step A7). More specifically, the host CPU 420 transmits a request signal for requesting the long-term prediction ephemeris data 485 to the server system 3. Then, the host CPU 420 receives the long-term prediction ephemeris data 485 from the server system 3 and stores the long-term prediction ephemeris data 485 in the flash ROM 480.

When it is determined that the command operation is position calculation command operation in step A1 (step A1; position calculation command operation), the host CPU 420 reads and executes the position calculation program 4711 stored in the ROM 470 to perform the position calculation process (step A9).

FIGS. 12 and 13 are flowcharts showing the flow of the position calculation process.

Initially, the host CPU 420 executes capture target satellite determining process (step B1). More specifically, the host CPU 420 determines the GPS satellite SV positioned in the sky above the latest calculation position 487 stored in the flash ROM 480 at the current date and time by using the almanac data 481 and sets the corresponding GPS satellite SV as the capture target satellite. It is possible to determine the capture target satellite by using the ephemeris data for each satellite 483 or the long-term prediction ephemeris data 485 instead of the almanac data 481.

Then, the host CPU 420 performs the process of loop A for each of the capture target satellites determined in step B1 (step B3 through B35). In the process of loop A, the host CPU 420 determines whether the ephemeris data of the corresponding capture target satellite (ephemeris data for each satellite 483) is stored in the flash ROM 480 or not (step B5).

When it is determined that the ephemeris data of the capture target satellite is stored (step B5; YES), the host CPU 420 determines whether the current date and time is contained in the effective term 4833 stored in the ephemeris data for each satellite 483 of the corresponding capture target satellite (step B7). When it is determined that the current date and time is contained (step B7; YES), the satellite position and satellite speed of the corresponding capture target satellite are calculated using the satellite orbit parameters stored in the ephemeris data for each satellite 483 of the corresponding capture target satellite (step B9).

The host CPU 420 also calculates a satellite clock correction amount at the current date and time using the clock correction parameter stored in the ephemeris data for each satellite 483 of the corresponding capture target satellite (step B11).

A satellite clock correction amount “Δt” at a time “t” can be approximated by the following equation (1) using a reference time “t_{c}” of the satellite clock, an offset “a₀” of the satellite clock, a drift “a₁” of the satellite clock, and a drift “a₂” of the satellite clock frequency as the clock correction parameters.

Δt=a₀+a₁(t−t_{c})+a₂(t−t_{c})² (1)

Then, the host CPU 420 performs the satellite capturing process (step B13). More specifically, the host CPU 420 calculates Doppler frequency when the GPS satellite signals of the corresponding capture target satellite are received at the latest calculation position 487 by using the satellite position and satellite speed of the capture target satellite calculated in step B9. Then, the host CPU 420 sets search frequency and search range when the GPS satellite signals are received from the capture target satellite based on the Doppler frequency thus calculated, and causes the CPU 415 of the baseband processing circuit unit 413 to capture the GPS satellite signals within the set search frequency and search range.

Then, the host CPU 420 determines whether the GPS satellite signals are continuously received from the corresponding capture target satellite or not (step B15). When it is determined that the GPS satellite signals are being received (step B15; YES), the host CPU 420 determines whether acquisition of the ephemeris data of the capture target satellite has been finished or not (step B17). Generally, 20 to 30 seconds are required until acquisition of ephemeris data is finished from start of reception of GPS satellite signals.

When it is determined that acquisition of the ephemeris data has been finished (step B17; YES), the host CPU 420 updates the ephemeris data for each satellite 483 stored in the flash ROM 480 by the obtained ephemeris data (step B19).

The host CPU 420 calculates a pseudo distance between the cellular phone 4 and the corresponding capture target satellite by using the code phase of the GPS satellite signals of the captured capture target satellite (step B21). Then, the host CPU 420 shifts the process to the next capture target satellite.

When it is determined that the GPS satellite signals are not continuously received from the corresponding capture target satellite in step B15 (step B15; NO), or when it is determined that acquisition of ephemeris data is not finished in step B17 (step B17; NO), the host CPU 420 shifts the flow to step B21.

When it is determined that the ephemeris data for each satellite 483 of the corresponding capture target satellite is not stored in step B5 (step B5; NO), or when the current date and time is not contained in the effective term 4833 stored in the ephemeris data for each satellite 483 of the corresponding capture target satellite in step B7 (step B7; NO), the host CPU 420 determines whether the long-term prediction ephemeris data 485 is stored in the flash ROM 480 (step B23).

When it is determined that the long-term prediction ephemeris data 485 is stored (step B23; YES), the host CPU 420 determines whether the current date and time is contained in any of the prediction target terms of the long-term prediction ephemeris data 485 (step B25). When it is determined that the current date and time is contained (step B25; YES), the host CPU 420 determines the prediction target term containing the current date and time (hereinafter referred to as “current prediction target term”) (step B27).

Then, the host CPU 420 calculates the satellite position and the satellite speed of the corresponding capture target satellite by using the satellite orbit parameter of the current prediction target term stored in the long-term prediction ephemeris data 485 (step B29). Also, the host CPU 420 calculates the satellite clock correction amount of the corresponding the capture target satellite according to the equation (1) by using the clock correction parameter of the current prediction target term stored in the long-term prediction ephemeris data 485 (step B31). Then, the host CPU 420 shifts the flow to step B13.

When it is determined that the long-term prediction ephemeris data 485 is not stored in step B23 (step B23; NO), or when it is determined that the current date and time is not contained in any of the prediction target terms of the long-term prediction ephemeris data 485 in step B25 (step B25; NO), the host CPU 420 performs the long-term prediction ephemeris acquisition process to obtain and store the long-term prediction ephemeris data 485 from the server system 3 (step B26). Then, the host CPU 420 shifts the flow to step B27.

After performing the process of loop A (steps B3 through B35) for all of the capture target satellites, the host CPU 420 ends the process of loop A. Then, the host CPU 420 executes position convergence calculation by least squared method, for example, for all of the capture target satellites based on the satellite position calculated in step B9 or B29, the satellite clock correction amount calculated in step B11 or B31, and the pseudo distance calculated in step B21 (step B37). Then, the host CPU 420 stores the obtained calculation position 493 in the RAM 490, and updates the latest calculation position 487 in the flash ROM 480.

The host CPU 420 outputs the calculation position 493 stored in the RAM 490 to the display unit 440 to display a navigation screen on the display unit 440 (step B39). Then, the host CPU 420 determines whether position calculation end command operation has been issued from the user through the operation unit 430 (step B41). When it is determined that the position calculation end command was not issued (step B41; NO), the flow returns to step B1. When it is determined that the position calculation end command has been issued (step B41; YES), the position calculation process ends.

Returning to the main process shown in FIG. 11, the host CPU 420 having performed any of the processes in steps A3 through A9 determines whether power supply cutoff command operation has been issued from the user through the operation unit 430 (step A11). When it is determined that the power supply cutoff command operation was not issued (step A11; NO), the flow returns to step A1. When it is determined that the power supply cutoff command operation has been issued (step A11; YES), the main process ends.

### 6. Operation and Advantage

The cellular phone 4 of the position calculation system 1 determines whether both the ephemeris of the GPS satellites SV transmitted from the GPS satellites SV and having the first effective term (such as 4 hours) and the long-term prediction ephemeris produced by the server system 3 and having the second effective longer than the first effective term (such as 1 week) as ephemeris predicting the satellite orbits of the GPS satellites SV are retained. When it is determined that both are retained, the position of the cellular phone 4 is calculated based on the ephemeris.

The long-term prediction ephemeris is data predicting the satellite orbits of the GPS satellites SV for a period longer than that of the ephemeris, and the reliability of the predicted satellite orbits is lower than the reliability of the satellite orbits of the ephemeris. Thus, when both of the ephemeris and the long-term prediction ephemeris are retained, position calculation is performed based not on the long-term prediction ephemeris but on the ephemeris in preference to the long-term prediction ephemeris. By this method, accuracy in position calculation can be increased.

The cellular phone 4 obtains the ephemeris by receiving the GPS satellite signals transmitted from the GPS satellites. In case that the ephemeris is not obtained according to the determination and that acquisition of the ephemeris is not completed, the cellular phone 4 calculates the position by using the long-term prediction ephemeris. Generally, 20 to 30 seconds are required until acquisition of the ephemeris is completed from start of reception of the GPS satellite signals. Thus, it is preferable to perform position calculation using the long-term prediction ephemeris until acquisition of ephemeris is completed.

### 7. Modified Example

### 7-1. Position Calculation System

According to this embodiment, the position calculation system 1 including the server system 3 and the cellular phone 4 has been described as an example. However, the position calculation system of the invention is not limited to this example. For example, the invention is applicable to electronic devices such as a portable personal computer, a PDA (personal digital assistant), and a car navigation device including the position calculating device as well as the cellular phone 4.

### 7-2. Satellite Position Calculation System

While the GPS has been used as the satellite position calculation system in this embodiment, the satellite position calculation system may be WAAS (wide area augmentation system), QZSS (quasi zenith satellite system), GLONASS (global navigation satellite system), GALILEO or other satellite position calculation systems.

7-3. Acquisition of Ephemeris from Base Station

Ephemeris may be obtained not only by demodulation of the GPS satellite signals but from a base station communicating with the cellular phone 4. The server of the base station regularly obtains and stores ephemeris from the GPS satellites SV observable from the base station. When receiving an ephemeris request signal from the cellular phone 4, the server of the base station transmits the stored ephemeris to the cellular phone 4. Thus, the server of the base station functions as an information providing device for obtaining and providing ephemeris.

In this case, a second main program and a second position calculation program as sub-routine of the second main program are stored in the ROM 470 of the cellular phone 4. The host CPU 420 reads and executes these programs to perform a second main process and a second position calculation process.

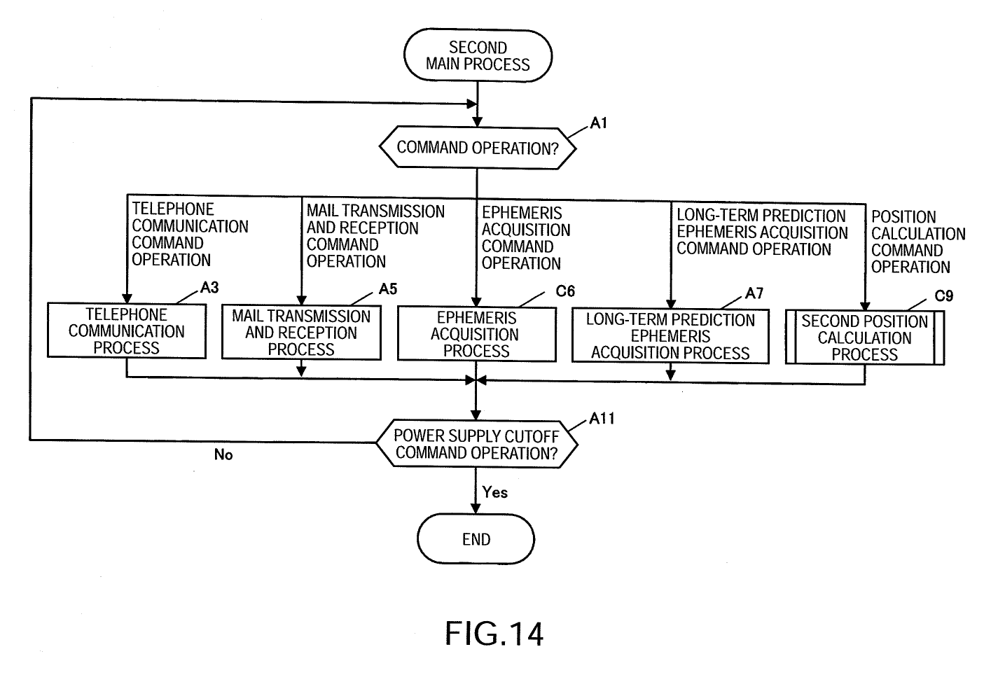

FIG. 14 is a flowchart showing the flow of the second main process. Similar reference numbers are given to steps similar to those of the main process shown in FIG. 11, and the same explanation is not repeated. In the following description, only parts different from those of the main process are touched upon.

When it is determined that the command operation is ephemeris acquisition command operation in step A1 (step A1; ephemeris acquisition command operation), the host CPU 420 performs ephemeris acquisition process (step C6). More specifically, the host CPU 420 transmits a request signal for requesting ephemeris to a base station currently communicable with the host CPU 420. Then, the host CPU 420 receives the ephemeris from the communication base station and stores the ephemeris in the flash ROM 480 as the ephemeris data for each satellite 483.

When it is determined that the command operation is position calculation command operation in step A1 (step A1; position calculation command operation), the host CPU 420 reads and executes the second position calculation program stored in the ROM 470 to perform the second position calculation process (step C9).

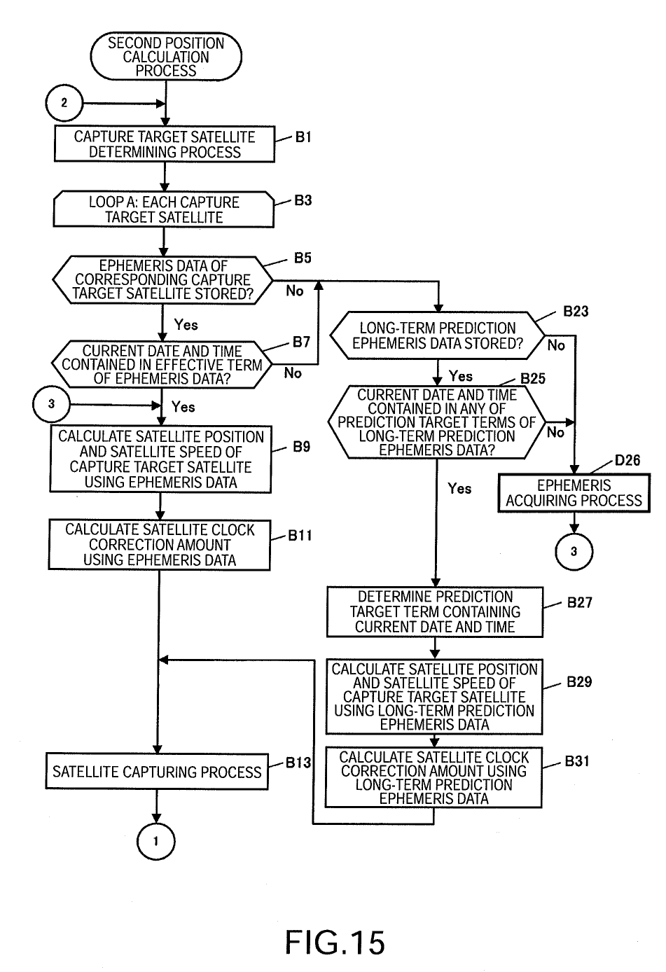

FIG. 15 is a flowchart showing the part corresponding to the position calculation process shown in FIG. 12 in the second position calculation process. Similar reference numbers are given to steps similar to those of the position calculation process, and the same explanation is not repeated. In the following description, only parts different from those of the position calculation process are touched upon.

When it is determined that the long-term prediction ephemeris data 485 is not stored in step B23 (step B23; NO), or when it is determined that the current date and time is not contained in any of the prediction target terms of the long-term prediction ephemeris data 485 in step B25 (step B25; NO), the host CPU 420 performs the ephemeris acquisition process to obtain and store the ephemeris data for each satellite 483 from the communication base station (step D26).

Then, the host CPU 420 shifts the process to step B9, and calculates the satellite position, satellite speed and the satellite clock correction amount by using the ephemeris data for each satellite 483 obtained from the communication base station (step B9 and B11).

According to this method, ephemeris is obtained from the base station when neither ephemeris nor long-term prediction ephemeris is retained. Thus, highly accurate position calculation can be achieved.

### 7-4. Production Target Period

According to this embodiment, long-term prediction ephemeris is produced for one week from the long-term prediction ephemeris date and time as production target period. However, the production target period may be a period longer than one week (such as two weeks), or a period shorter than one week (such as three days). The effective term of ephemeris transmitted from the GPS satellites SV is generally about four hours. Long-term prediction ephemeris is only required to have effective term longer than that of ephemeris. It is preferable that the effective term of long-term prediction ephemeris is 1 day or more.

### 7-5. Prediction Target Term

According to the examples described above, the length of the prediction target term is six hours. However, the length is not limited to this length but may be appropriately varied such as four hours and eight hours.

What is claimed is:

1. A position calculating method comprising:
determining whether satellite orbit data of a positioning satellite having a first effective term and long-term prediction orbit data having a second effective term longer than the first effective term and predicting a satellite orbit of the positioning satellite are retained or not; and
calculating a position by using the satellite orbit data when it is determined that the satellite orbit data and the long-term prediction orbit data are retained.

2. The position calculating method according to claim 1, further comprising:
determining whether a time is contained in the first effective term or not,
wherein calculating the position includes calculating the position by using the satellite orbit data when it is determined that the time is contained in the first effective term, and calculating the position by using the long-term prediction orbit data when it is determined that the time is not contained in the first effective term.

3. The position calculating method according to claim 1, wherein:
the positioning satellite modulates a positioning signal by satellite orbit data of the positioning satellite and transmits the modulated positioning signal;
the position calculating method further includes obtaining the satellite orbit data by receiving the positioning signal; and
calculating the position includes calculating the position by using the long-term prediction orbit data in case that the satellite orbit data is not retained according to the determination and that acquisition of the satellite orbit data is not completed.

4. The position calculating method according to claim 1, wherein calculating the position includes calculating the position by using the long-term prediction orbit data in case that the satellite orbit data is not retained and that the long-term prediction orbit data is retained according to the determination.

5. The position calculating method according to claim 1, further comprising receiving the satellite orbit data from an information providing device when it is determined that the satellite orbit data is not retained.

6. A position calculating device comprising:
a determining unit which determines whether satellite orbit data of a positioning satellite having a first effective term and long-term prediction orbit data having a second effective term longer than the first effective term and predicting a satellite orbit of the positioning satellite are retained or not; and
a position calculating unit which calculates a position by using the satellite orbit data when it is determined that the satellite orbit data and the long-term prediction data are retained.
